(19) United States
(12) Patent Application Publication
(10) Pub. No.: US 2006/0066131 A1
(43) Pub. Date: Mar. 30, 2006

(54) Bedlift with chain lift system for toy trailer

(76) Inventor: Michael W. Nebel, Smith Center, KS (US)

Correspondence Address: DARBY & DARBY P.C., P. O. BOX 5257, NEW YORK, NY, 10150-5257, US

(21) Appl. No.: 11/202,952

(22) Filed: Aug. 11, 2005

Related U.S. Application Data
(60) Provisional application No. 60/600,756, filed on Aug. 11, 2004.

(51) Int. Cl. B60P 3/32

(52) U.S. Cl. 296/156

(57) ABSTRACT

A bed lift mechanism raises and lowers two beds is provided and includes a first lifting assembly attached to one side of the bed including a pair of vertical chains guided by four lifting sprockets, the vertical chains and lifting sprockets disposed in a pair of vertical track members; and a second lifting assembly attached to another side of the bed including a pair of vertical chains guided by four lifting sprockets, the vertical chains and lifting sprockets disposed in a pair of vertical track members. A single drive mechanism transfers rotational motion to the lifting sprockets which are coupled to each other to move synchronously. The bed lift also provides multiple safety mechanisms to prevent the beds from drifting down unintentionally.

### CROSS-REFERENCE TO RELATED APPLICATION

This application claims the benefit of U.S. Provisional Patent Application No. 60/600,756, filed Aug. 11, 2004, which is hereby incorporated by reference in its entirety.

### TECHNICAL FIELD

The present invention relates to lift mechanisms, and more particularly, relates to a lift mechanism that moves a bed in a controlled manner from a lowered position to a raised position.

### BACKGROUND

Conventional recreational vehicles (RVs) are available in a number of different types depending upon the size requirements and other desires of the purchaser. For example, the purchaser or user can select an RV that is motorized and can be driven by itself or one can be selected that requires a tow vehicle to tow the RV. Consumers increasingly want additional, increased interior room and also want to be provided with additional options available with the RV. One option that has found increasing commonality in the recent years is the incorporation of a rear section of the RV for storing one or more all-terrain vehicles (ATVs), dirt bikes, or other types of all-terrain, off-road, and recreational vehicles or motorized equipment, such as lawn mowers, etc. The section for storing the ATVs can be incorporated into any number of different types of RVs including motor homes and fifth wheel trailer type RVs. An RV for storing ATVs is often referred to as a “toy trailer” or “toy hauler.”

The toy trailer can include all the amenities of a conventional RV. The rear section can be an entirely separate area that is divided from a living area by a wall and a door. The incorporation of furniture in the rear section of the toy trailer is desirable since it results in an increase in the available space for use as a living area after the ATVs have been unloaded. Oftentimes the toy trailer has a pull down bed, benches, or tables that can fold up, via hinges or other device, against the inside of the side walls of the rear section of the toy trailer. By mounting a pull down bed, bench, or table to the side walls of the rear section, the user can simply swing the bed, bench, or table down when desired. The pull down bed, benches, or tables can swing down after the ATVs have been removed from the toy trailer.

When the ATVs are to be loaded back into the toy trailer, the bed, bench, or table is placed back in its storage positions, thereby increasing the overall available interior space in the rear section of the toy trailer.

The bed, bench and table are typically mounted on the side walls of the rear section. However, each bed, bench, or table decreases the amount of available space in the rear section of the toy trailer, since they must be stored on the side walls alongside the ATVs. Thus, there is less space in the toy trailer to store the ATVs.

U.S. Pat. No. 5,092,650 relates to a bed stored in an overhead area of a front portion of an RV where the driver and passenger seating is located. The bed is lowered when the RV is parked. A motor and a pair of torque tubes are disposed parallel to two side rails of the bed frame and are coupled so that the motor and torque tubes rotate together. The torque tubes span the length of the bed between two end rails positioned near the respective side walls of the RV. The torque tubes, the motor, and the side rails of the bed frame take up a significant amount of space, thereby increasing the amount of space required for installing and operating the bed. Furthermore, there are several rotating components exposed underneath the bed, e.g., the torque tubes and the motor, that are a safety hazard since items can be caught between the rotating components, thereby preventing the use of the underside of the bed between the side rails as a storage area. In addition, there are no safety mechanisms for preventing the bed from inadvertently dropping. Moreover, the motor moves with the bed, thereby requiring power cables to the motor to rise and fall with the movement of the motor. Having the power cable move up and down with the motor and the bed creates an unattractive appearance and a potential safety hazard.

What has heretofore not been available is an alternative reliable lift mechanism for easily and smoothly moving the bed, bench, or table between the lowered position and the raised position and provides a large amount of storage space, while providing a small, motorized RV.

What has also heretofore not been available is an alternative reliable lift mechanism with multiple safety mechanisms for preventing the bed from inadvertently dropping from the raised position.

### SUMMARY

According to one aspect of the present invention, a lift mechanism mounted to a support for raising and lowering a first bed and a second bed is provided and includes: (a) a drive mechanism coupled to a frame; (b) a first driven support member that is operatively coupled to the drive mechanism for controllably being driven along vertical rails of the frame, wherein the first driven support member is associated with and supporting the first bed; (c) a second support member associated with the second bed and supporting the second bed; and (d) a plurality of stop members removably fixed along the vertical rails for adjustably fixing a distance between the first and second beds in a lowered position thereof.

The first driven support member is constructed so that it can freely pass over the stop members fixed in the vertical rails as the first bed is driven to a raised position or the lowered position, while the second support member has a feature that engages the stop members and prevents further vertical motion of the second support member along the vertical rails as the first and second beds are moved to the lowered position.

According to another embodiment and aspect of the present invention, a bed lift mechanism is mounted to a support and raises and lowers two beds. The bed lift mechanism includes a first lifting assembly attached to a first side of a first bed, the first lifting assembly comprising at least one first chain guided by a first upper lifting sprocket and a first lower lifting sprocket and a first bottom bracket connected to the first chain, the first bottom bracket being attached to the first side of the first bed; a second lifting assembly attached to a second side of the first bed, the second lifting assembly comprising at least one second chain guided by a second upper lifting sprocket and a second lower lifting sprocket and a second bottom bracket connected to the second chain, the second bottom bracket being attached to the second side of the first bed; a drive mechanism for transferring rotational motion to the first upper lifting sprocket, the first upper lifting sprocket being operatively coupled to the second upper lifting sprocket so that the rotational motion from first upper lifting sprocket is transferred to the second upper lifting sprocket; a first frame assembly and a second frame assembly mounted to a support, the first frame assembly comprising at least one track member at least partially housing the first lifting assembly, the second frame assembly comprising at least one track member at least partially housing the second lifting assembly; a first top bracket attached to a first side of a second bed, the first top bracket being supported by the first bottom bracket as the second bed is lowered until the first top bracket is stopped by a first stopper mounted to the first frame assembly; a second top bracket attached to a second side of the second bed, the second top bracket being supported by the second bottom bracket as the second bed is lowered until the second top bracket is stopped by a second stopper mounted to the second frame assembly; wherein the first upper lifting sprocket and the second upper lifting sprocket transfer the rotational motion to controllably move the respective first and second bottom brackets and the first and second beds between respective raised positions and lowered positions.

A bed lift mechanism, according to another embodiment of the present invention, provides a safety mechanism and raises and lowers a bed. This bed lift mechanism includes a safety sprocket coupled to the first lifting sprocket so that the safety sprocket and the first lifting sprocket rotate synchronously; a drive mechanism for transferring rotational motion to a safety sprocket and to the first lifting sprocket in the first lifting assembly; a plate supported by the first frame assembly; and a locking rod attached to the first frame assembly to controllably move the plate, wherein the plate can be engaged with teeth of the safety sprocket to prevent the first lifting sprocket from rotating thereby preventing the bed from moving between a raised position and a lowered position.

A bed lift mechanism, according to yet another embodiment of the present invention, provides raises and lowers a bed using at least four chains. The bed lift mechanism includes a first lifting assembly attached to a first side of a bed, the first lifting assembly comprising a first chain guided by a first upper lifting sprocket and a first lower lifting sprocket, a first bottom bracket connected to the first chain, a second chain guided by a second upper lifting sprocket and a second lower lifting sprocket, and a second bottom bracket connected to the second chain, the first bottom bracket and the second bottom bracket being attached to the first side of the bed; a second lifting assembly attached to a second side of the bed, the second lifting assembly comprising a third chain guided by a third upper lifting sprocket and a third lower lifting sprocket, a third bottom bracket connected to the third chain, a fourth chain guided by a fourth upper lifting sprocket and a fourth lower lifting sprocket, and a fourth bottom bracket connected to the fourth chain, the third bottom bracket and the fourth bottom bracket being attached to the second side of the bed.

### BRIEF DESCRIPTION OF THE DRAWINGS

The foregoing and other features of the present invention will be more readily apparent from the following detailed description and drawings of the illustrative embodiments of the invention wherein like reference numbers refer to similar elements and in which:

FIG. 1 is a perspective view of a toy trailer with a bed lift mechanism according to an embodiment of the present invention;

FIG. 2 is an exploded perspective view of the bed lift mechanism of FIG. 1;

FIG. 3 is an exploded perspective view of a drive mechanism on a first end of the power side assembly of the bed lift mechanism of FIG. 1;

FIG. 4 is an exploded perspective view of a cross bar at the first end of the power side assembly of the bed lift mechanism of FIG. 1;

FIG. 5 is an exploded perspective view of a second end of the power side assembly of the bed lift mechanism of FIG. 1;

FIG. 6 is an exploded perspective view of a bottom end of a vertical track member of the bed lift mechanism of FIG. 1;

FIG. 7 is a front view of a safety mechanism of the bed lift mechanism of FIG. 1 in an engaged position;

FIG. 8 is a front view of the safety mechanism of FIG. 7 in a disengaged position;

FIG. 9 is a front view of a safety mechanism of another embodiment of the bed lift mechanism in an engaged position;

FIG. 10 is a front view of the safety mechanism of FIG. 9 in a disengaged position;

FIG. 11 is a perspective view of a bottom bracket of the bed lift mechanism of FIG. 1;

FIG. 12 is a front view of the bottom bracket of FIG. 11;

FIG. 13 is a front view of a top bracket of the bed lift mechanism of FIG. 1;

FIG. 14 is a rear view of the top bracket of FIG. 13;

FIG. 15 is an exploded perspective view of a stopper and the vertical track member of the bed lift mechanism of FIG. 1;

FIG. 16 a perspective view of the top bracket and the vertical track member of the bed lift mechanism of FIG. 1;

FIG. 17 is a side view of the first end of the power side assembly of the bed lift mechanism of FIG. 1 as the beds are lowered from their topmost raised positions;

FIG. 18 is a side view of the first end of the power side assembly of the bed lift mechanism of FIG. 1 when the second bed is at its bottommost lowered position as the beds are lowered from their topmost raised positions;

FIG. 19 is a side view of the first end of the power side assembly of the bed lift mechanism of FIG. 1 with both of the beds at their bottommost lowered positions;

FIG. 20 is a side view of the first end of the power side assembly of the bed lift mechanism as the beds move from their bottommost lowered positions to raised positions; and

FIG. 21 is a side view of the first end of the power side assembly of the bed lift mechanism with the beds in their topmost raised positions.

### DETAILED DESCRIPTION OF THE PREFERRED EMBODIMENTS

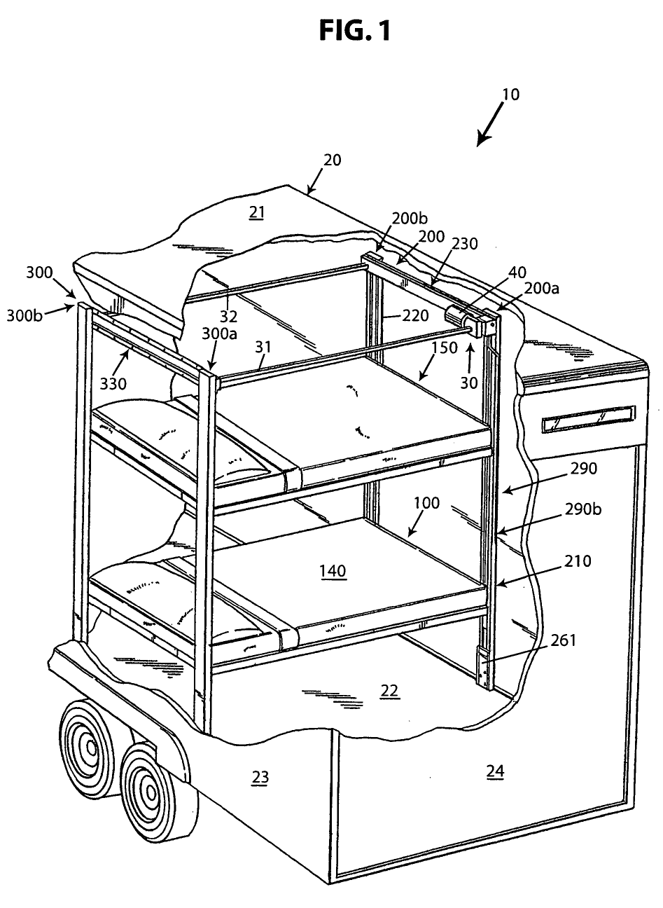

FIGS. 1-21 illustrate an embodiment of a bed lift mechanism in an exemplary toy trailer 10, which is an RV that has a rear section for storing one or more all-terrain vehicles (ATVs), dirt bikes, or other types of all-terrain, off-road, and recreational vehicles, or motorized equipment. The RV can be any type of RV including motor homes and fifth wheel trailer type RVs. As previously mentioned, an RV for storing ATVs is often referred to as a “toy trailer” or “toy hauler”.

Various drive mechanisms for use with toy trailers and the like are disclosed in U.S. patent application Ser. No. 10/916,112, published as U.S. patent Publication No. 2004/0262947; U.S. patent application Ser. No. 10/916,253, published as U.S. patent Publication No. 2005/0001449, U.S. patent application Ser. No. 10/903,922, published as U.S. patent Publication No. 2004/0262946; U.S. patent application Ser. No. 10/915,984, published as U.S. patent Publication No. 2004/0262949; each of these applications is hereby incorporated herein by reference in its entirety.

The toy trailer typically includes a ramp (not shown) that opens into the rear section for allowing the ATVs to be loaded into the rear section of the toy trailer. The ramp drops down similarly to ramps in typical cargo trailers.

In most, if not all, toy trailers, a bed can be provided which can be raised and lowered over a height difference such as 9 feet. After the ATVs have been unloaded from the rear section of the toy trailer, the bed can be lowered and used for additional sleep accommodations. The ATVs can be loaded back into the rear section of the toy trailer when the beds are raised back into the original position.

There are a number of different type of RVs that can be adapted into a toy trailer depending upon a particular individual's needs, desires, and wishes. For example, one type of RV is a motor home that is a self-contained motorized RV that looks something like a bus and is often referred to as a “coach.” This type of RV includes a number of different rooms and amenities that can provide superior comfort. Another type of RV is a travel trailer that is designed to be towed by a vehicle having hitch equipment for securely mating with the frame of the tow vehicle. Yet another type of RV is called a fifth wheel trailer (often referred to as a “fifth wheel”) which is a trailer that is designed to be towed by a vehicle, such as a pickup truck, that is equipped with a special hitch in a bed portion of the tow vehicle because of their layouts and constructions, fifth wheel vehicles are particularly suited for conversion to a toy trailer.

FIGS. 1-21 illustrate an RV adapted as a toy trailer 10; however, it will be understood that the present invention can be incorporated into various types of RVs, including those mentioned above. The toy trailer 10 includes a main cabin or housing (not shown), which includes the front portion of the toy trailer 10 and typically includes rooms, such as a master bedroom, kitchen, bathroom, closets, etc. A door (not shown) for entering the interior of the main cabin can be provided in this section.

The exemplary toy trailer 10 of FIGS. 1-21 has at least one lift mechanism 30 which is controllably movable from a raised position to a lowered position for the purpose of providing a bed 100 in a rear section 20 of the toy trailer 10 after the ATVs have been removed. As shown in FIG. 1, the rear section 20 of the toy trailer 10 includes a ceiling section 21, a floor section 22, side walls 23, a front wall (not shown), a rear door 24, and a ramp (not shown) for loading and unloading the ATVs. The ramp can be dropped down to the ground after opening the rear door 24 and can be retracted back into the rear section 20 of the toy trailer 10 before closing the rear door 24.

The lift mechanism 30 functions as a mechanical drive mechanism for causing the controlled lifting and lowering of the bed 100. By actuating the lift mechanism, the bed 100 can be lowered from the raised position which is near the ceiling section 21 to the lowered position which is near the floor section 22 of the rear section 20 of the toy trailer 10. When the bed 100 is in the lowered position, the lift mechanism 30 can be actuated to raise the bed 100 from the lowered position to the raised position.

The bed lift mechanism 30 is incorporated into the rear section 20 of the toy trailer 10 for raising or lowering the bed 100; however, it is understood that the lift mechanism of the present invention is not limited to the rear section of a toy trailer but rather it can be incorporated into other rooms of the toy trailer, including those mentioned above.

The bed 100 includes a bed support bracket 110 which supports a bed frame 120. The bed frame 120 preferably supports a platform (not shown), and a mattress 140 is placed on top of the platform; however, the mattress 140 can be removed to use the space above the platform for storage.

The platform can be a section of plywood or some other type of sturdy, flat material fastened to the bed frame 120, so that the lift mechanism 30 can be used to raise and lower the platform. Supplies and other items can be stored on the platform. Thus, it is understood that the lift mechanism 30 of the present invention is not limited to being used as a personal bed but can be used as a storage shelf for lifting other types of loads.

The bed lift mechanism 30 of the present invention also allows a second bed 150 to be installed so that the bed lift mechanism 30 can be used to deploy the two separate beds 100, 150. The second bed 150 is positioned above the first bed 100 in the bed lift mechanism 30. Although the embodiment of the present invention shown in FIGS. 1-21 and described herein includes two separate beds 100, 150, it is to be understood that the second bed 150 is optional and is not necessary to the invention. Thus, the bed lift mechanism 30 can be provided to deploy a single bed 100 or can be provided to deploy multiple beds 100, 150.

The lift mechanism 30 can be constructed in a number of different manners, using a number of different drive arrangements, including the following embodiment.

Bed Lift Mechanism

The embodiment of the chain-driven bed lift mechanism 30 shown in FIGS. 1-21, which is driven with four vertical chains 219, 229 and two horizontal chains 239 to raise and lower the beds 100, 150. It will be appreciated that each of the chains can also be referred to as a flexible drive member or a drive element that mates with and is entrained over other drive members.

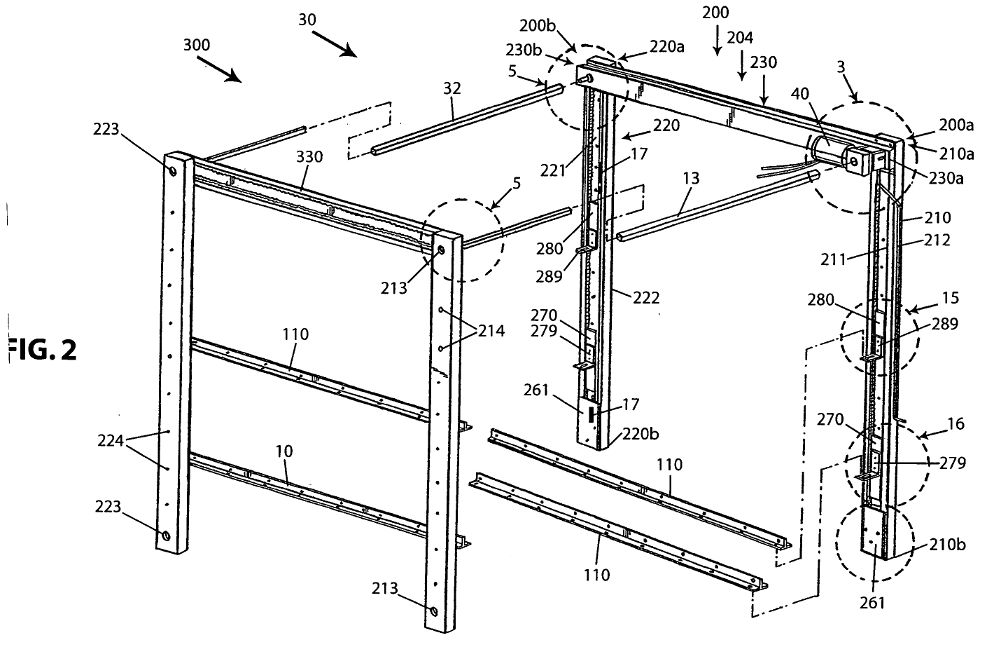

FIG. 1 is a perspective view of the toy trailer 10 with the bed lift mechanism 30, and FIG. 2 is an exploded perspective view of the bed lift mechanism 30.

The bed lift mechanism 30 includes a power side assembly 200 and a slave side assembly 300. The power and slave side assemblies 200, 300 are mounted to the opposite side walls 23 of the rear section 20 of the toy trailer 10.

The difference between the power side assembly 200 and the slave side assembly 300 is that the power side assembly 200 is directly connected to a drive mechanism 40, such as a worm gear assembly with a manual hand crank, a motor, or a motor with a manual override. The manual override can be a worm gear assembly as a self-locking system that eliminates the need for a break on the motor to keep the beds 100, 150 from drifting down.

In the embodiment of the present invention shown in FIGS. 1-21, the drive mechanism 40 is a motor 41 with a manual override 42. The manual override 42 is positioned so that the operator can reach the manual override 42 even when the beds 100, 150 are in their topmost raised positions.

The slave side assembly 300 is not connected directly to the drive mechanism 40 and is instead driven directly by the power side assembly 200. A pair of telescoping cross shafts 31, 32 are telescopically extended or retracted to be able to connect to both of the power side assembly 200 and the slave side assembly 300. The length of each of the telescoping cross shafts 31, 32 can be adjusted so that bed frames 120 of varying length can be mounted to the power side assembly 200 and the slave side assembly 300. The advantage of using a telescoping cross shaft is that it permits only one shaft to be manufactured or produced that is sized to fit and work well in a number of different bed assemblies of different dimensions.

Power Side Assembly

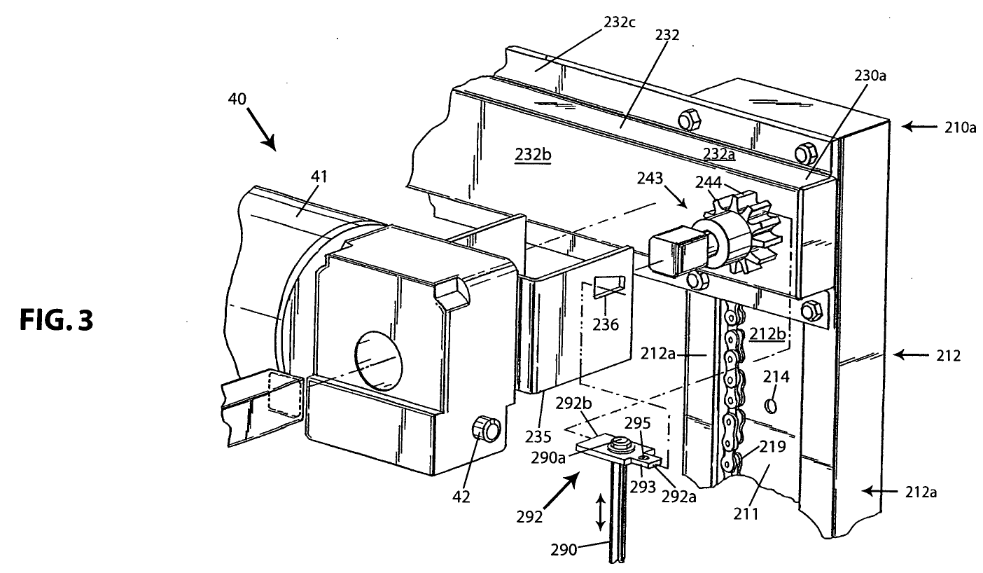

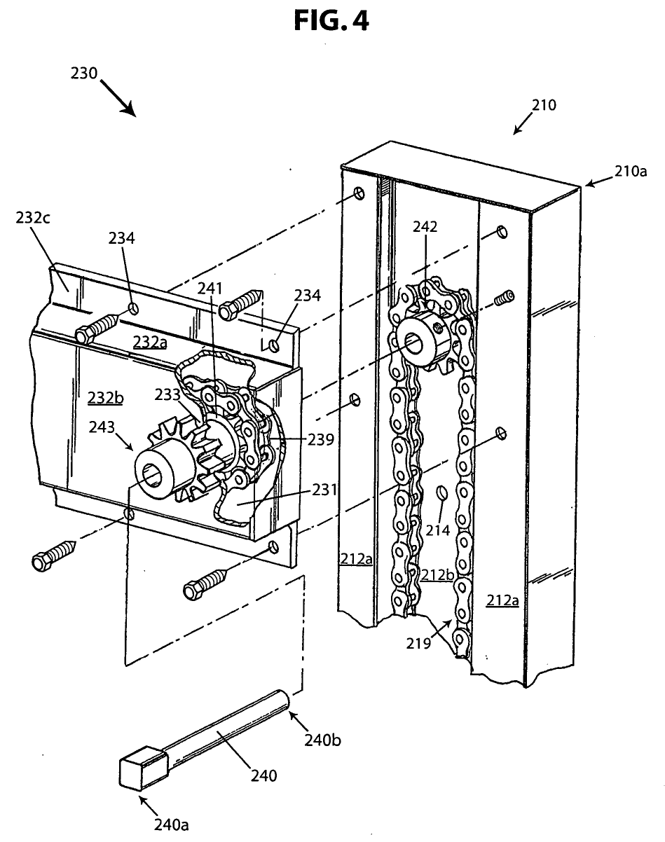

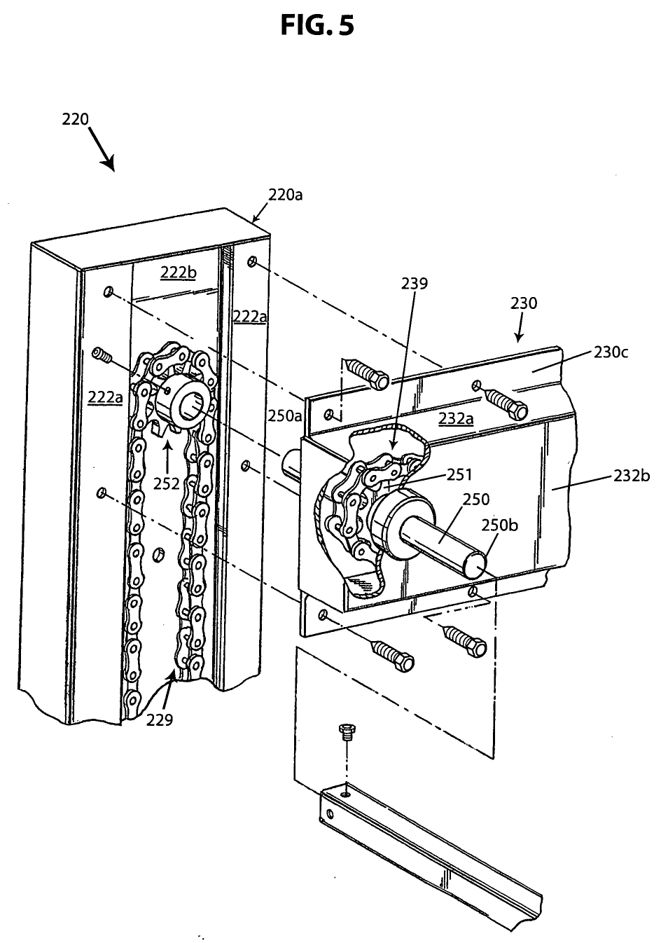

FIG. 3 is an exploded perspective view of a drive mechanism 40 on a first end 200a of the power side assembly 200 of the bed lift mechanism 30; FIG. 4 is an exploded perspective view of the first end 200a of the power side assembly 200 of the bed lift mechanism 30; and FIG. 5 is an exploded perspective view of a second end 200b of the power side assembly 200 of the bed lift mechanism 30. The first end 200a of the power side assembly 200 is located closer to the drive mechanism 40 than the second end 200b of the power side assembly 200.

The power side assembly 200 includes a frame 204. The frame 204 is mounted to the side wall 23 of the toy trailer 10 closest to the power side assembly 200 and remains stationary with respect to the beds 100, 150 as the beds 100, 150 are raised and lowered. The two beds 100, 150 are supported by the same frame 204 in the power side assembly 200. The frame 204 of the power side assembly 200 includes a pair of vertical track members 210, 220 and a cross bar 230.

A pair of vertical track members 210, 220 are provided in each of the power side assembly 200 and the slave side assembly 300; however, it is to be understood that for smaller sized beds, e.g., twin beds, a single vertical track member can be provided in each of the power side assembly 200 and the slave side assembly 300.

Vertical Track Members

Each of the first and the second vertical track members 210, 220 includes a top end 210a, 220a and a bottom end 210b, 220b. Preferably, the top ends 210a, 220a of the vertical track members 210, 220 are positioned close to the ceiling 21 of the toy trailer 10 and the bottom ends 210b, 220b of the vertical track members 210, 220 are positioned close to the floor 22 of the toy trailer 10. The vertical track members 210, 220 are mounted to the side walls 23 of the toy trailer 10, e.g., using an angle bracket (not shown) mounted to the top ends 210a, 220a of the vertical track members 210, 220 and another angle bracket (not shown) mounted to the bottom ends 210b, 220b of the vertical track members 210, 220.

Each of the vertical track members 210, 220 includes a channel 211, 221 formed within a U-shaped member 212, 222 that includes a pair of sides 212a, 222a and a base 212b, 222b. The angle brackets are mounted to the top ends 210a, 220a and the bottom ends 210b, 220b of the vertical track members 210, 220 are fastened, e.g., using screws, to the side walls 23 of the toy trailer 10.

The first vertical track member 210 is positioned at the first end 200a of the power side assembly 200, and the second vertical member 220 is positioned at the second end 200b of the power side assembly 200.

Cross Bar

The cross bar 230 is preferably positioned at the top ends 210a, 220a of the first and second vertical track members 210, 220 and spans the width of the beds 100, 150 between the two vertical track members 210, 220. A first end 230a of the cross bar 230 is disposed near the first vertical track member 210, and a second end 230b of the cross bar 230 is disposed near the second vertical track member 220.

The cross bar 230 has a channel 231 formed within a U-shaped member 232 that includes a pair of sides 232a joined by a base 232b. The cross bar 230 is positioned so that the channel 231 opens toward the side walls 23 of the toy trailer 10 and toward the first and second vertical track members 210, 220.

The cross bar 230 is provided with a pair of flanges 232c extending toward each other from the respective sides 232a of the U-shaped member 232. The flanges 232c are provided with holes 234 at each end 230a, 230b of the cross bar 230 to mount the ends 230a, 230b of the cross bar 230 to the sides 212a, 222a of the first and second vertical track members 210, 220.

Drive Shaft And Upper Slave Shaft

The base 232b of the cross bar 230 is provided with shaft supporting holes 233 for supporting a first end 240a of a drive shaft 240 and a first end 250a of an upper slave shaft 250. Second ends 240b, 250b of the drive shaft 240 and the upper slave shaft 250 are connected to a respective end of the telescoping cross shafts 31, 32. The drive shaft 240 and the upper slave shaft 250 are parallel to each other and are both perpendicular to the cross bar 230.

The base 212b of the first vertical track member 210 is also provided with a shaft supporting hole 213 for supporting the drive shaft 240, and the base 222a of the second vertical track member 220 is provided with a shaft supporting hole 223 for supporting the upper slave shaft 250.

A drive mechanism mounting bracket 235 mounts the drive mechanism 40 onto the cross bar 230 close to the first end 200a of the power side assembly 200. The drive mechanism mounting bracket 235 is provided on the first end 230a of the cross bar 230 on the side of the base 232b of the cross bar 230 that faces the beds 100, 150.

At the first end 200a of the power side assembly 200, a drive sprocket 241 disposed within the cross bar 230, a first upper lifting sprocket 242 disposed within the first vertical track member 210, and a safety sprocket 243 disposed within the drive mechanism mounting bracket 235 are rotatably fixed to the drive shaft 240. The rotational motion from the drive shaft 240 is transferred to the drive sprocket 241, the first upper lifting sprocket 242, and the safety sprocket 243. The drive sprocket 241 is positioned on the drive shaft 240 between the first upper lifting sprocket 242 and the safety sprocket 243. The purpose of the safety sprocket 243 is described below.

At the second end 200b of the power side assembly 200, a slave sprocket 251 disposed within the cross bar 230 and a second upper lifting sprocket 252 disposed within the second vertical track member 220 are rotatably fixed to the upper slave shaft 250. The rotational motion from the upper slave shaft 250 is transferred to the slave sprocket 251 and the second upper lifting sprocket 252.

Horizontal Chain

The horizontal chain 239, which is formed as a closed-loop chain, is positioned inside the channel 231 of the cross bar 230. The horizontal chain 239 is supported and guided by the drive sprocket 241 on the drive shaft 240 and the slave sprocket 251 on the upper slave shaft 250, which are also disposed inside the channel 231 of the cross bar 230.

The drive mechanism 40 transfers rotational motion to the drive shaft 240, which transfers the rotational motion to the drive sprocket 241. The horizontal chain 239, which is guided by the drive sprocket 241, transfers the rotational motion from the drive sprocket 241 to the slave sprocket 251, and the slave sprocket 251 transfers the rotational motion to the upper slave shaft 250. Therefore, the horizontal chain 239 allows the upper slave shaft 250 to be turned synchronously with the drive shaft 240, thereby allowing both telescoping shafts 31, 32, which are mounted to the second ends 240b, 250b of the drive shaft 240 and the upper slave shaft 250, to be turned synchronously.

Lower Slave Shafts

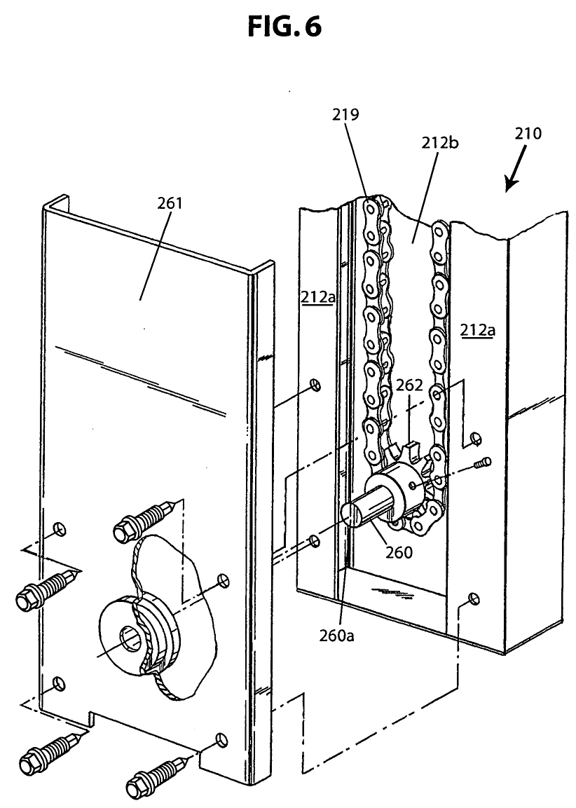

FIG. 6 is an exploded perspective view of the bottom end 210b of the first vertical track member 210 of the bed lift mechanism 30. It is to be understood that the bottom end 220b of the second vertical track member 220 is similar to the bottom end 210b of the first track member 210 shown in FIG. 6. Therefore, the components of the bed lift mechanism 30 at the bottom ends 210b, 220b of the first and second vertical track members 210, 220 are denoted by the same reference characters.

A pair of mounting plates 261 are fastened to the bottom ends 210b, 220b of the vertical track members 210, 220 to close the respective channels 211, 221 within the vertical track members 210, 220. Each of the mounting plates 261 support first ends 260a of a pair of lower slave shafts 260 disposed within the bottom ends 210b, 220b of the respective vertical track members 210, 220. The bases 212b, 222b of the vertical track members 210, 220 are each provided with a respective shaft supporting hole 213, 223 for supporting second ends (not shown) of the lower slave shafts 260.

A first lower lifting sprocket 262 disposed within the first vertical track member 210 is rotatably fixed to the first lower slave shaft 260. A second lower lifting sprocket 262 disposed within the second vertical track member 220 is rotatably fixed to the second lower slave shaft 260.

Vertical Chain

A pair of vertical chains 219, 229 are positioned inside the respective channels 211, 221 of the vertical track members 210, 220. The first vertical chain 219 is supported and guided by the first upper lifting sprocket 242 on the drive shaft 240 and the first lower lifting sprocket 262 on the first lower slave shaft 260, which are also disposed inside the channel 211 of the first vertical track member 210. The second vertical chain 229 is supported and guided by the second upper lifting sprocket 252 on the upper slave shaft 250 and the second lower lifting sprocket 262 on the second lower slave shaft 260, which are also disposed inside the channel 221 of the second vertical track member 220. Thus, the horizontal chain 239, which transfers motion from the drive shaft 240 to the upper slave shaft 250, allows both vertical chains 219, 229 to be moved synchronously.

The drive mechanism 40 transfers rotational motion to the drive shaft 240, which transfers the rotational motion to the first upper lifting sprocket 242. The horizontal chain 239 allows the upper slave shaft 250, which transfers the rotational motion to the second upper lifting sprocket 252, to be turned synchronously with the drive shaft 240. Therefore, the first upper lifting sprocket 242 on the drive shaft 240 and the second upper lifting sprocket 252 on the upper slave shaft 250 are turned synchronously, thereby allowing the vertical chains 219, 229, which are guided by the first upper lifting sprocket 242 and the second upper lifting sprocket 252, respectively, to turn synchronously.

The rotational motion is then transferred via the first vertical chain 219 from the drive shaft 240 to the first lower slave shaft 260, and the rotational motion is transferred via the second vertical chain 229 from the upper slave shaft 250 to the second lower slave shaft 260.

The vertical chains 219, 229 each support a bottom bracket 270, which supports the first bed 100. Thus, the rotation of the first and the second vertical chains 219, 229 serves to lift or lower the bottom bracket 270, thereby lifting or lowering the first bed 100.

Stoppers

As shown in FIG. 15, a plurality of stopper supporting holes 214, 224 are provided along the base 212b, 222b of the first and the second vertical track members 210, 220, at predetermined intervals, e.g., every 10 inches. A stopper 215, 225 is placed in one of the stopper supporting holes 214, 224 in each respective vertical track member 210, 220. The vertical positioning of the stoppers 215, 225 within the vertical track members 210, 220 determines the height of the lowered position of the second bed 150. Thus, the bottommost lowered position of the second bed 150 is determined by the height of the stoppers 215, 225. The height of the stoppers 215, 225 is selected by the operator of the bed lift mechanism 40 by selecting the set of stopper supporting holes 214, 224 for inserting the stoppers 215, 225.

In the embodiment of the present invention shown in FIGS. 1-21, a vertical track member 210, 220 is provided at each corner of the beds 100, 150. Therefore, each of the four vertical track members 210, 220 is provided with the stopper supporting holes 214, 224 and the stopper 215, 225. Therefore, each set of stopper supporting holes 214, 224, corresponding to different heights for the second bed 150, should be provided at the same height along each of the vertical track members 210, 220 to ensure that the second bed 150 is level when it is positioned at its bottommost lowered position.

Safety Mechanism

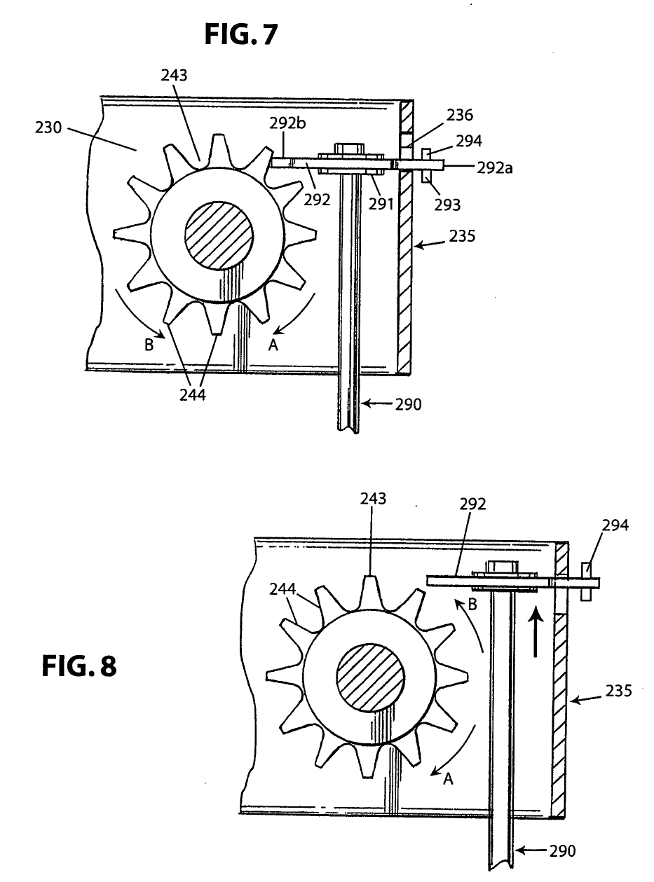

FIG. 7 is a front view of a safety mechanism of the bed lift mechanism 30 in an engaged position; and FIG. 8 is a front view of the safety mechanism of FIG. 7 in a disengaged position.

The safety mechanism includes a locking rod 290 mounted to the first end 200a of the power side assembly 200. The locking rod 290 acts as a safety precaution against unwanted downward movement of the beds 100, 150.

The locking rod 290 has a top end 290a and a bottom end 290b. A washer 291 is mounted to the top end 290a of the locking rod 290. The bottom end 290b of the locking rod 290 serves as a handle for being gripped by the operator. When the operator of the bed lift mechanism 30 pushes the locking rod 290 upward, the washer 291 at the top end 290a of the locking rod 290 contacts a locking plate 292 mounted to the drive mechanism mounting bracket 235.

The locking rod 290 can be mounted by brackets (not shown) to the outside surface of the first vertical track member 210. The brackets allow the locking rod 290 to slide vertically parallel to the first vertical track member 210. One of the brackets can be provided inside the drive mechanism mounting bracket 235 to position the top end 290a of the locking rod 290 close to the washer 291. Thus, the washer 291 can be supported by the bracket, thereby providing increased support vertically to the locking rod 290.

The locking plate 292 has a first end 292a and a second end 292b and is preferably made of a strong and durable material such as steel. The first end 292a of the locking plate 292 includes an arm 293 which is inserted through a locking plate mounting hole 236 in the drive mechanism mounting bracket 235. A fastener 294, such as a cotter pin, is attached to a hole 295 in the arm 293 of the locking plate 292 to ensure that the arm 293 is positioned within the locking plate mounting hole 236 in the drive mechanism mounting bracket 235.

The positioning of the locking plate 292 in the locking plate mounting hole 236 allows the locking plate 292 move vertically with respect to the safety sprocket 243. When the operator of the bed lift mechanism 30 pushes up on the locking rod 290, as shown in FIG. 10, the washer 291 at the top end 290a of the locking rod 290 pushes up on the second end 292b of the locking plate 292 mounted to the drive mechanism mounting bracket 235, thereby forcing the second end 292b of the locking plate 292 to lift up to thereby disengage the locking plate 292 from teeth 244 of the safety sprocket 243.

When the operator of the bed lift mechanism 30 pushes up on the locking rod 290, the second end 292b of the locking plate 292 disengages from the teeth 244 of the safety sprocket 243. While the locking plate 292 is disengaged from the safety sprocket 243, the safety sprocket 243, the drive shaft 240, the drive sprocket 241, and the first upper lifting sprocket 242 are allowed to rotate, and the operator can activate the drive mechanism 40 to lower the beds 100, 150.

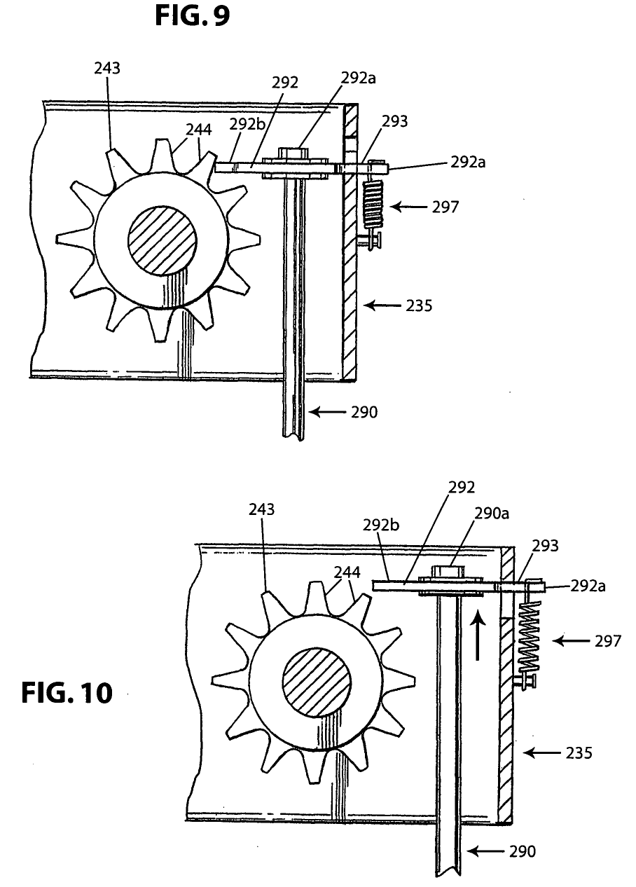

When the operator of the bed lift mechanism 30 releases the locking rod 290, the second end 292b of the locking plate 292 is free to fall as far as a bottom surface of the locking plate mounting hole 236 to thereby reengage the locking plate 292 with the teeth 244 of the safety sprocket 243, as shown in FIG. 9.

As the drive mechanism 40 is activated to lower the beds 100, 150, if the operator releases the bottom end 290b of the locking rod 290, the locking plate 292 falls into the next space between the teeth 244 of the safety sprocket 243.

When the operator of the bed lift mechanism 30 is not pushing up on the locking rod 290, gravity forces the second end 292b of the locking plate 292 to engage with the teeth 244 of the safety sprocket 243 on the drive shaft 240. Thus, the locking plate 292 prevents the safety sprocket 243 from rotating, thereby preventing the drive shaft 240 from rotating. When the drive shaft 240 is prevented from rotating, the first vertical chain 219, which is guided by the drive sprocket 241 on the drive shaft 240 and the horizontal chain 239, which is guided by the first upper lifting sprocket 242 on the drive shaft 240, are also prevented from moving. Thus, the operator is prevented from operating the drive mechanism 40 to lower the beds 100, 150.

The locking rod 290 is positioned on the side of the safety sprocket 243 to prevent unwanted downward movement of the beds 100, 150. However, if the operator activates the drive mechanism 40 to lift the beds 100, 150 upward, the safety sprocket 243 is free to rotate regardless of whether the locking plate 292 is engaged in the teeth 244 of the safety sprocket 243. As the safety sprocket 243 rotates in the direction to lift the beds 100, 150, the locking plate 292 is positioned so that it cannot engage the teeth 244 of the safety sprocket 243 to prevent the rotation of the safety sprocket 243.

As shown in FIGS. 7 and 8, arrow A indicates the direction of rotation of the safety sprocket 243 and the drive shaft 240 to allow the beds 100, 150 to lower. Arrow B indicates the direction of rotation of the safety sprocket 243 and the drive shaft 240 to allow the beds 100, 150 to be raised. When the safety sprocket 243 and the drive shaft 240 rotate in the direction of arrow B, the locking plate 292 cannot engage with the teeth 244 of the safety sprocket 243.

The locking rod 290 provides a reliable safety mechanism for preventing unwanted downward movement of the beds 100, 150. If the operator does not push up on the safety rod 290 and the locking plate 292 has engaged with the teeth 244 of the safety sprocket 243, the beds 100, 150 cannot be lowered unless all of the teeth 244 on the safety sprocket 243 break off from the safety sprocket 243, which is unlikely for typical sprockets. Moreover, if the drive mechanism 40 fails, the locking rod 290 and locking plate 293 would prevent the beds 100, 150 from falling and would automatically prevent the bed lift mechanism 40 from operating.

FIG. 9 is a front view of a safety mechanism of another embodiment of the bed lift mechanism 30 in an engaged position; and FIG. 10 is a front view of the safety mechanism of FIG. 9 in a disengaged position. The embodiment of the safety mechanism shown in FIGS. 9 and 10 is the same as the embodiment shown in FIGS. 7 and 8, but also includes a spring 297 to pull the locking plate 293 down to the engaged position when the user releases the locking rod 290.

Bottom Bracket

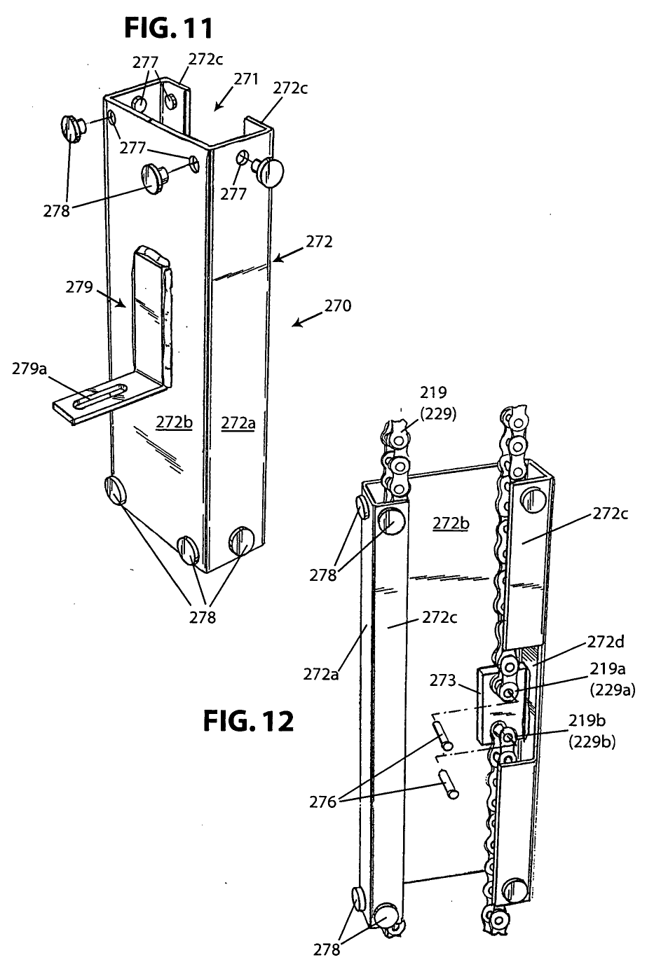

FIG. 11 is a perspective view of a bottom bracket 270 of the bed lift mechanism 30; and FIG. 12 is a front view of the bottom bracket 270 of FIG. 11.

The bottom brackets 270 are guided by the respective first and second vertical chains 219, 229 within the channels 211, 221 of the first and the second vertical track members 210, 220. Each of the bottom brackets 270 includes a channel 271 formed within a U-shaped member 272 that includes a pair of sides 272a joined by a base 272b. The bottom bracket 270 is positioned so that the channel 271 opens toward the respective base 212b, 222b of the first or second vertical track member 210, 220.

The bottom bracket 270 is provided with a pair of flanges 272c extending toward each other from the respective sides 272a of the U-shaped member 272. One of the flanges 272c includes an opening 272d in which a block 273 is fixedly disposed. The block 273 includes two chain coupling holes (not shown). The first chain coupling hole is vertically aligned with and positioned above the second chain coupling hole.

The vertical chain 219, 229 is disposed within the channel 271 of the bottom bracket 270 between the base 272b and the flanges 272c of the U-shaped member 272. Therefore, the bottom bracket 270 is formed large enough to enclose the vertical chain 219, 229 without damaging the bottom bracket 270. Furthermore, the block 273 is inlaid into the bottom bracket 270 deep enough so that the vertical chains 219, 229 can be disposed in the gap between the block 273 and the flanges 272c of the U-shaped member 272.

Unlike the horizontal chain 239, each of the vertical chains 219, 229 is not formed in a closed-loop chain and include a first end 219a, 229a and a second end 219b, 229b. The first end 219a, 229a of each of the vertical chains 219, 229 is connected via chain couplers 276, e.g., pins, to the first chain coupling hole. The second end 219b, 229b of the vertical chains 219, 229 are connected via chain couplers 276, e.g., pins, to the second chain coupling hole. Therefore, the block 273 of the bottom bracket 270 connects to the first ends 219a, 229a and the second ends 219b, 229b of the vertical chain 219, 229 to form a closed loop.

The blocks 273 are positioned with respect to the first vertical chain 219 and the second vertical chain 229 so that all of the blocks 273 are located at substantially the same height. Therefore, each corner of the first bed 100 is located at substantially the same height.

The blocks 273 in the bottom brackets 270 are positioned with respect to the first vertical chain 219 and the second vertical chain 229 so that all of the blocks 273 are lowered as the drive mechanism 40 rotates the drive shaft 240 in a first direction, e.g., the direction of arrow A as shown in FIGS. 7 and 8, and all of the blocks 273 are raised as the drive mechanism 40 rotates the drive shaft 240 in a second direction, e.g., the direction of arrow B, which is opposite arrow A.

The blocks 273 are also positioned with respect to the first vertical chain 219 and the second vertical chain 229 so that as the drive shaft 240 rotates in the first direction, the vertical chains 219, 229 rotate to lower the blocks 273 in the bottom brackets 270 at the same time and at the same speed. As the drive shaft 240 rotates opposite in the second direction, the vertical chains 219, 229 rotate to raise the blocks 273 in the bottom brackets 270 at the same time and at the same speed.

The sides 272a, the base 272b, and the flanges 272c of the bottom bracket 270 include multiple glide plug mounting holes 277 for mounting multiple glide plugs 278. The glide plugs 278 are preferably formed of UHMW (ultra high molecular weight) plastic or another type of material that can glide smoothly against the sides 212a, 222a and the base 212b, 222b of the vertical track members 210, 220.

An angle bracket 279 is provided on the base 272b of the bottom bracket 270, on the opposite side as the channel 271. The angle bracket 279 includes a slot 279a formed perpendicular to the surface of the base 272b of the bottom bracket 270. The bed support bracket 110 is mounted to the slot 279a in the angle bracket 279.

Top Bracket

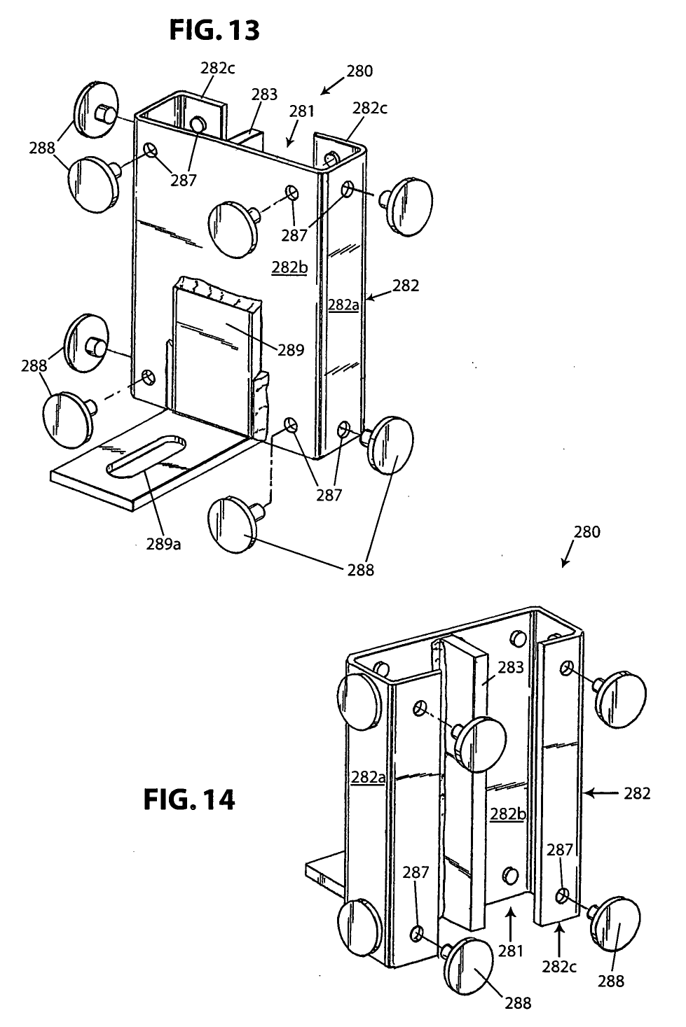

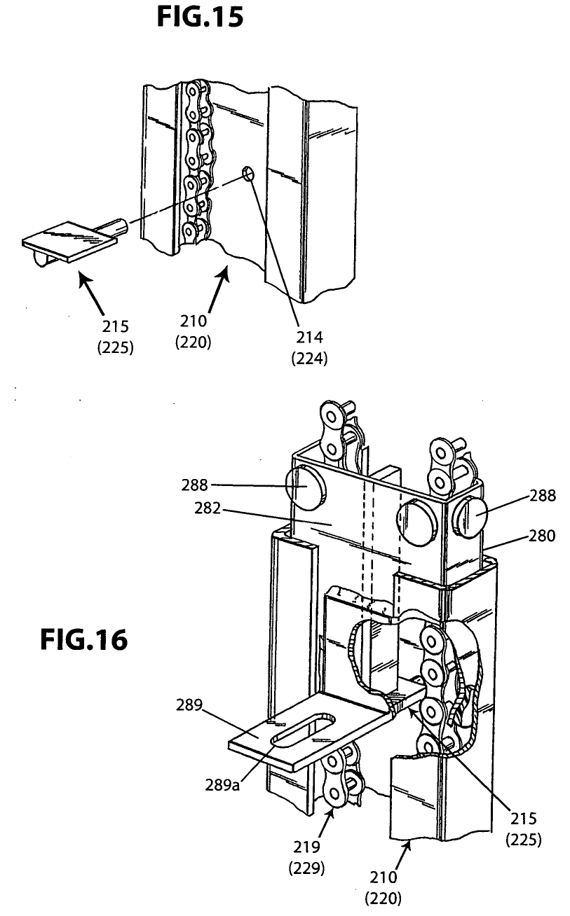

FIG. 13 is a front view of a top bracket 280 of the bed lift mechanism 30; FIG. 14 is a rear view of the top bracket 280 of FIG. 13; FIG. 15 is an exploded perspective view of the stopper 215 and the vertical track member 210 of the bed lift mechanism 30; and FIG. 16 a perspective view of the top bracket 280 and the vertical track member 210 of the bed lift mechanism 30.

The top bracket 280 allows the second bed 150 to be deployed by the bed lift mechanism 30 with the first bed 100 while both beds 100, 150 are supported by the same frame 204 in the power side assembly 200. The second bed 150 is positioned above the first bed 100 in the bed lift mechanism 30.

The top brackets 280 are guided by the bottom brackets 270 within the channels 211, 221 of the first and the second vertical track members 210, 220 so that as the beds 100, 150 are lowered from the topmost raised positions, the top brackets 280 rest on top of the respective bottom brackets 270.

Each of the top brackets 280 includes a channel 281 formed within a U-shaped member 282 that includes a pair of sides 282a joined by a base 282b. The top bracket 280 is positioned so that the channel 281 opens toward the respective base 212b, 222b of the first or second vertical track member 210, 220.

The top bracket 280 is provided with a pair of flanges 282c extending toward each other from the respective sides 282a of the U-shaped member 282. The ends 219a, 219b, 229a, 229b of the vertical chains 219, 229 are disposed within the channels 281 of the top brackets 280 between the base 282b and the flanges 282c of the U-shaped member 282. Therefore, the top bracket 280 is formed large enough to enclose the vertical chain 219, 229 without damaging the top bracket 280.

The U-shaped member 282 of the top bracket 280 is shaped similar to the U-shaped member 272 of the bottom bracket 270. However, the top bracket 280 can be shorter and does not include an opening in the flange or a block for coupling to the vertical chains 219, 229.

Furthermore, the top bracket 280 includes a vertical stop plate 283 mounted longitudinally along the center of the channel 281 between the sides 282a of the U-shaped member 282. In the embodiment of the invention shown in FIGS. 1-21, the vertical stop plate 283 extends along the entire length of the channel 281. However, it is to be understood that the length of the vertical stop plate 283 can be modified, for example, to alter the distance between the two beds 100, 150 at their bottommost lowered positions.

As the beds 100, 150 are lowered, the top brackets 280 stop moving downward when the vertical stop plates 283 contact the respective stoppers 215, 225 in the vertical track members 210, 220. Thus, each of the vertical stop plates 283 within the channel 281 of the top bracket 280 is extends far enough from the base 283b toward the flanges 282c of the top bracket 280 so that the vertical stop plate 283 can reach the corresponding stopper 215, 225, thereby allowing the second bed 150 to stop at the bottommost lowered position selected by the operator of the bed lift mechanism 30.

Similar to the bottom bracket 270, the sides 282a, the base 282b, and the flanges 282c of the top bracket 280 include multiple glide plug mounting holes 287 for mounting multiple glide plugs 288. The glide plugs 288 are preferably formed of UHMW (ultra high molecular weight) plastic or another type of material that can glide smoothly against the sides 212a, 222a and the base 212b, 222b of the vertical track members 210, 220.

An angle bracket 289 is provided on the base 282b of the top bracket 280, on the opposite side as the channel 281. The angle bracket 289 includes a slot 289a formed perpendicular to the surface of the base 282b of the bottom bracket 280. The bed support bracket 110 is mounted to the slot 289a in the angle bracket 289.

Bed Support Bracket

The bed support bracket 110 is mounted to the slots 279a, 289a in the angle brackets 279, 289 of the bottom bracket 270 and the top bracket 280. The slots 279a, 289a in the angle brackets 279, 289 extend away from the vertical track members 210, 220 and the side wall 23 of the toy trailer 10. The slots 279a, 289a are generally perpendicular to the surface of the side walls 23 and allow the assembler of the bed lift mechanism 30 to align the bed support bracket 110 properly with respect to the angle brackets 279, 289 before fastening the bed support bracket 110 to the angle brackets 279, 289.

Slave Side Assembly

The first end 300a of the slave side assembly 300 is opposite to the first end 200a of the power side assembly 200, and a second end 300b of the slave side assembly 300 is opposite to the second end 200b of the power side assembly 200.

The components of the slave side assembly 300 that are identical to the corresponding parts of the power side assembly 200 are denoted by identical reference characters and will not be described in detail.

The difference between the slave side assembly 300 and the power side assembly 200 is that the power side assembly 200 includes the drive mechanism 40, such as a crank or a motor. Rotational motion is then supplied to the slave side assembly 300 via the telescoping shafts 31, 32, which connect the slave side assembly 300 to the power side assembly 200.

Telescoping Shafts

The telescoping shafts 31, 32 are mounted to the respective second ends 240b, 250b of the drive shaft 240 and the upper slave shaft 250 using a fastener such as a bolt and hex nut. The respective telescoping shafts 31, 32 can be extended telescopically to connect the drive shaft 240 and the upper slave shaft 250 of the power side assembly 200 to a drive shaft 240 and an upper slave shaft 250 of the slave side assembly 300, respectively. The drive shaft 240 of the slave side assembly 300 is identical to the drive shaft 240 in the power side assembly 200 except that the drive shaft 240 of the slave side assembly 300 is not connected directly to a drive mechanism, since the slave side assembly 300 does not include a separate drive mechanism.

Each of the telescoping shafts 31, 32 is shown as a square shaft in FIGS. 1-5; however, it is understood that the telescoping shaft 31, 32 can be formed having a cross section with a different shape as long as it can be extended or retracted telescopically to connect the power side assembly 200 to the slave side assembly 300. Thus, the length of the telescoping shafts 31, 32 can be adjusted so that bed frames of varying length can be included in the bed lift mechanism 30.

A cross bar 330 in the slave side assembly 300 is similar to the cross bar 230 in the power side assembly 200 except that the cross bar 330 in the slave side assembly 300 does not include a drive mechanism mounting bracket since the slave side assembly 300 does not include a drive mechanism.

Installation

The installation of the bed lift mechanism 30 in the toy trailer 10 will now be described.

First, the power side assembly 200, without the telescoping shafts 31, 32, is fastened onto one of the side walls 23 of the toy trailer 10, and the slave side assembly 300 is fastened onto the opposite side wall 23 of the toy trailer 10. Thus, the power side assembly 200 and the slave side assembly 300 are installed in the toy trailer 10 before installing the bed frame 120.

Then, the first telescoping shaft 31 is fastened to the second end 240b of the drive shaft 240 of the power side assembly 200. The second telescoping shaft 32 is fastened to the second end 250b of the upper slave shaft 250 of the power side assembly 200. The lengths of the telescoping shafts 31, 32 are adjusted so that the free ends of the telescoping shafts 31, 32 can be fastened to the drive shaft 240 of the slave side assembly 300 and the first end 250a of the upper slave shaft 250 of the slave side assembly 300, respectively. It is to be understood that alternatively the telescoping shafts 31, 32 can be connected to the slave side assembly 300 before the power side assembly 200.

The bed frame 120 is positioned on the bed support brackets 110 in the power side assembly 200 and in the slave side assembly 300, and then the bed frame 120 is fastened in place.

If a motor is provided, the motor is hooked up to a power source before operating the bed lift mechanism 30.

Operation

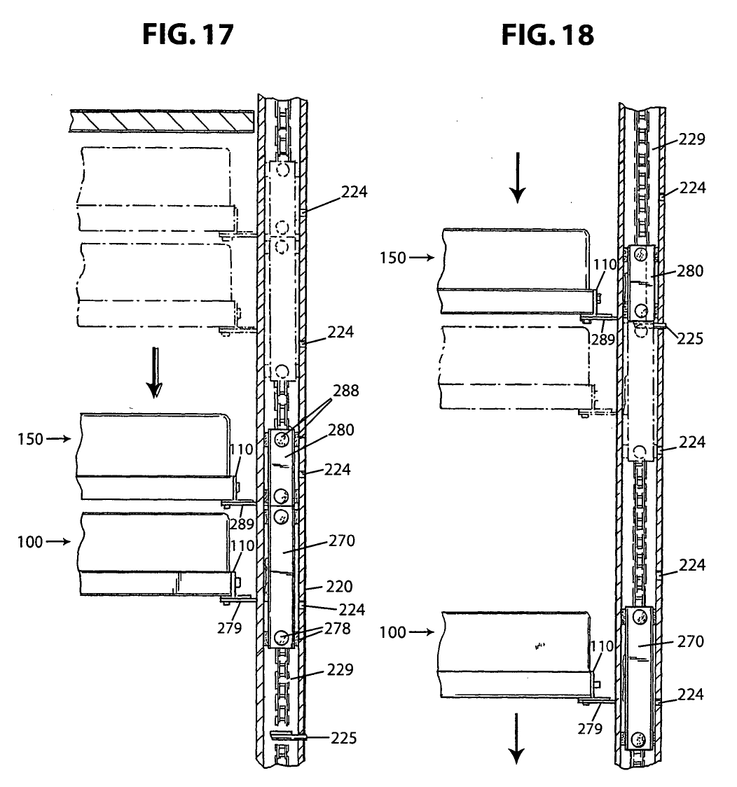

The operation of the lift mechanism 30 is illustrated in FIGS. 17-21 and will now be described with the beds 100, 150 starting in their topmost raised positions.

FIG. 17 is a side view of the first end 200a of the power side assembly 200 of the bed lift mechanism 30 as the beds 100, 150 are lowered from their topmost raised positions. The beds 100, 150 in their topmost raised positions are shown in dashed lines, and the beds 100, 150 in lowered positions are shown in solid lines.

When a user wants to lower the beds 100, 150, the user activates the lift mechanism 30 by operating the drive mechanism 40, which is attached to the power side assembly 200. As the user activates the drive mechanism 40, the drive shaft 240 connected to the drive mechanism 40 rotates, thereby rotating the drive sprocket 241 disposed on the drive shaft 240. The rotation of the drive shaft 240 causes the first upper lifting sprocket 242 and the safety sprocket 243 to rotate, since the first upper lifting sprocket 242 and the safety sprocket 243 are also non-rotatably disposed on the drive shaft 240.

The drive sprocket 241 drivingly engages the horizontal chain 239, which encircles the drive sprocket 241 and the slave sprocket 251 on the upper slave shaft 250. The rotational motion from the horizontal chain 239 causes the slave sprocket 251 to rotate, and since the slave sprocket 251 is non-rotatably disposed on the upper slave shaft 250, the slave sprocket 251 causes the upper slave shaft 250 to rotate. The rotation of the upper slave shaft 250 causes the second upper lifting sprocket 252 to rotate, since the second upper lifting sprocket 252 is also non-rotatably disposed on the upper slave shaft 250.

The first upper lifting sprocket 242 drivingly engages the first vertical chain 219, which encircles the first upper lifting sprocket 242 and the first lower lifting sprocket 262, which is disposed on the first lower slave shaft 260. The rotational motion from the first vertical chain 219 also causes the first lower lifting sprocket 262 to rotate.

The second upper lifting sprocket 252 drivingly engages the second vertical chain 229, which encircles the second upper lifting sprocket 252 and the second lower lifting sprocket 262, which is disposed on the second lower slave shaft 260. The rotational motion from the second vertical chain 229 also causes the second lower lifting sprocket 262 to rotate.

Thus, the rotation of the drive shaft 240 in the power side assembly 200 causes the rotation of the drive sprocket 241, the first upper lifting sprocket 242, the safety sprocket 243, the slave sprocket 251, the second upper lifting sprocket 252, the first lower lifting sprocket 262, and the second lower lifting sprocket 262 at the same rate and at the same time.

One end of the first telescoping shaft 31 is connected to the second end 240b of the drive shaft 240. The first telescoping shaft 31 transfers the rotational motion from the drive mechanism 40 via the drive shaft 240 of the power side assembly 200 to the drive shaft 240 of the slave side assembly 300. The opposite end of the first telescoping shaft 31 is fastened to the second end 240b of the drive shaft 240 in the slave side assembly 300.

One end of the second telescoping shaft 32 is connected to the second end 250b of the upper slave shaft 250. The second telescoping shaft 32 transfers the rotational motion from the upper slave shaft 250 of the power side assembly 200 to the upper slave shaft 250 of the slave side assembly 300. The opposite end of the second telescoping shaft 32 is fastened to the second end 250b of the upper slave shaft 250 in the slave side assembly 300.

Thus, the rotational motion of the drive shaft 240 in the power side assembly 200 is transferred via the first telescoping shaft 31 to the drive shaft 240 of the slave side assembly 300, and the rotational motion of the upper slave shaft 250 in the power side assembly 200 is transferred via the second telescoping shaft 32 to the upper slave shaft 250 in the slave side assembly 300.

The drive sprocket 241 on the drive shaft 240 and the slave sprocket 251 on the upper slave shaft 250 in the slave side assembly 300 are both driven by the rotational motion of the drive mechanism 40 in the power side assembly 200 via the telescoping shafts 31, 32.

At the topmost raised position shown in FIG. 17, the top brackets 280 rest on top of the respective bottom brackets 270. The bottom brackets 270 and the top brackets 280 are aligned so that the vertical chains 219, 229 pass through the channels 271, 281 within the bottom brackets 270 and the top brackets 280. As the vertical chains 219, 229 lower the bottom brackets 270 along the vertical track members 210, 220, the top brackets 280 are also lowered since they rest on top of the bottom brackets 270.

As described above, the bottom brackets 270 are lowered synchronously as the drive mechanism 40 rotates the drive shaft 240 in the first direction, e.g., the direction of arrow A as shown in FIGS. 7 and 8. As the bottom brackets 270 are lowered from the topmost raised position, the top brackets 280 are also lowered since the top brackets 280 rest on top of the bottom brackets 270 after the beds 100, 150 are lowered from the topmost raised position.

As the second bed 150 is lowered, the top bracket 280 will eventually be lowered far enough so that the vertical stop plate 283 in the top bracket 280 rests against the stopper 215, 225 in the vertical track member 210, 220. Thus, the stopper 215, 225 prevents the vertical stop plate 283 in the top bracket 280 from lowering farther than the height set by the stopper 215, 225.

FIG. 18 is a side view of the power side assembly of the bed lift mechanism 30 when the second bed 150 is at its bottommost lowered position as the beds 100, 150 are lowered from their topmost raised positions. The second bed 150 is shown in solid lines and is located at its bottommost lowered position as the top bracket 280 rests against the stopper 225 in the second vertical track member 220. The first bed 100 in dashed lines is located at the position where it last contacted the second bed 150 before descending downward toward its lowered position shown in solid lines.

As the first bed 100 is lowered, the first bed 100 can be lowered past the stopper 215, 225 in the vertical track member 210, 220 since the bottom bracket 270 is formed without a vertical stop plate 283. Therefore, the bottom bracket 270 is able to bypass the stopper 215, 225 and can be lowered farther than the height of the stopper 215, 225 in the vertical track members 210, 220.

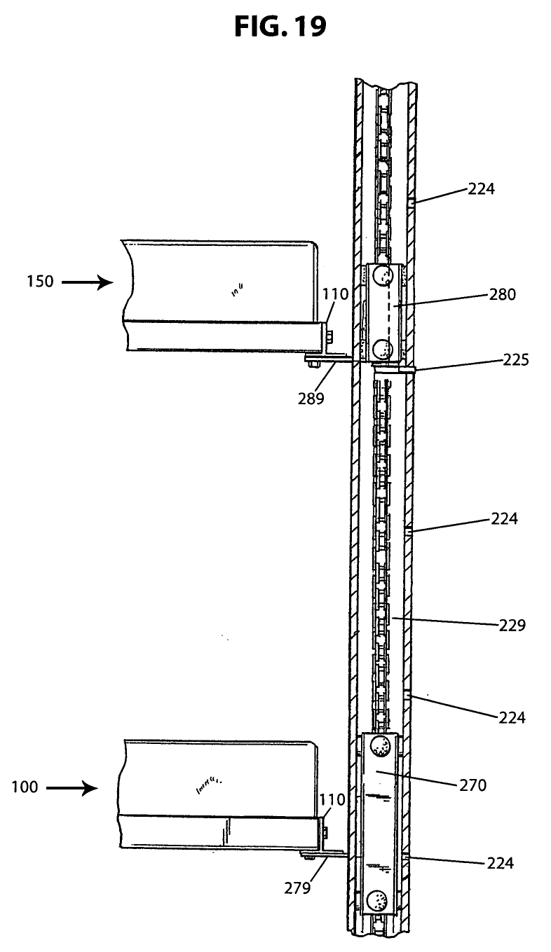

FIG. 19 is a side view of the first end 200a of the power side assembly 200 of the bed lift mechanism 30 with both of the beds 100, 150 at their bottommost lowered positions. The second bed 150 is still shown in solid lines at its bottommost lowered position, and the top bracket 280 rests against the stopper 225 in the second vertical track member 220. The first bed 100 is also in solid lines and is located at its bottommost lowered position where it is prevented from moving farther, e.g., after contacting the top edge of the lower shaft mounting plates 261 at the bottom ends 210b, 220b of the vertical track members 210, 220.

At this position, the vertical stop plates 283 of the top brackets 280 rest against the stoppers 215, 225 in the vertical track members 210, 220, and the bottom brackets 270 have continued moving downward along the vertical track members 210, 220 past the position of the stoppers 215, 225.

At the position shown in FIG. 19, the first bed 100 has also reached its bottommost lowered position while the second bed 150 has remained at its bottommost lowered position.

After the first bed 100 has been lowered to its preferred height, the user can activate the drive mechanism 40 to lift the first bed 100 back to its original raised position. The operation of the bed lift mechanism 30 to raise the beds 100, 150 is the same as for the lowering operation described above except that the drive shaft 250 is rotated in the opposite direction. As a result, the gears rotate in the opposite direction, thereby causing the lift mechanism 30 to raise the beds 100, 150.

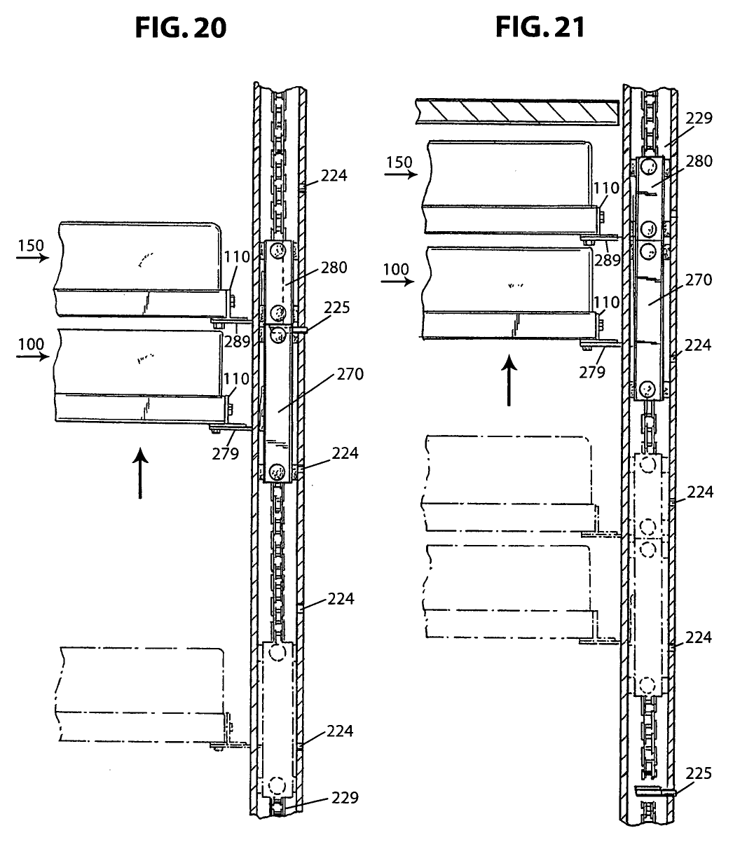

FIG. 20 is a side view of the first end 200a of the power side assembly 200 of the bed lift mechanism 30 as the beds 100, 150 move from their bottommost lowered positions to raised positions. The second bed 150 is shown in solid lines and is located at its bottommost lowered position, and the top bracket 280 rests against the stopper 225 in the second vertical track member 220. The first bed 100 in dashed lines is located at its bottommost lowered position. The first bed 100 in solid lines is located at the position where it first contacts the second bed 150 on its way upward toward its topmost raised position.

The bottom brackets 270 are raised via the blocks 273 as the drive mechanism 40 rotates the drive shaft 240 in a second direction, e.g., the opposite direction of arrow A. After the bottom brackets 270 contact the top brackets 280, the bottom brackets 270 will push the top brackets 280 upward. At this position, the second bed 150 is positioned on top of the first bed 100.

The beds 100, 150 stop their upward movement when the top brackets 280 have reached their topmost positions or the user has deactivated the drive mechanism 40.

FIG. 21 is a side view of the first end 200a of the power side assembly 200 of the bed lift mechanism 30 with the beds 100, 150 in their topmost raised positions. The beds 100, 150 in their topmost raised positions are shown in solid lines, and the beds 100, 150 in lowered positions are shown in dashed lines.

Advantages

The advantages of the belt lift mechanism 30 will now be described.

Since the drive shaft 240, the upper slave shaft 250, the lower slave shafts 260, and the telescoping shafts 31, 32 are driven collectively by the single drive mechanism 40, there is no risk of binding in the lift mechanism 30. Since the upper lifting sprockets 242, 252 and the lower lifting sprockets 262 in the four vertical track members 210, 220 in the power side assembly 200 and in the slave side assembly 300 are synchronized, there is no danger that a corner of the bed frames 120 would move at a faster rate than another corner. Furthermore, there is no danger that two different corners of the bed frames 120 would start or stop moving at different times. The lifting sprockets 242, 252, 262 at all of the corners of the bed frame 120 can be synchronized and driven at the same speed.

The lifting sprockets 242, 252, 262 engage with the vertical chains 219, 229 in the vertical track members 220, 221 in a non-slip manner, thereby preventing misalignment of the beds 100, 150. Furthermore, the lifting sprockets 242, 252, 262 are housed within the vertical track members 210, 220, thereby preventing anything such as fingers or clothing from being caught between the lifting sprockets 242, 252, 262.

Since the telescoping shafts 31, 32 are provided for connecting the power side assembly 200 to the slave side assembly 300, the lift mechanism 30 can be adapted for use with bed frames of varying lengths. Simply by extending or retracting the length of the telescoping shafts 31, 32, the lift mechanism 30 can be mounted to shorter or longer bed frames according to the user's preference.

The cross bars 230 and the telescoping shafts 31, 32 remain mounted close to the ceiling 21 of the toy trailer 10. Furthermore, all of the rotating parts are enclosed within the cross bars 230 and vertical track members 210, 220 in the power side assembly 200 and the slave side assembly 300. Therefore, fingers or other objects cannot be caught by the rotation of the rotating parts, thereby providing a safe design. Alternatively, a storage space (not shown) can be incorporated underneath the bed frames 120 since there are no exposed rotating parts.

The motor 41 can be provided in the drive mechanism 40 for powering the lift mechanism 30. Therefore, the lift mechanism 30 can be extended and retracted by pushing a button or by flipping a switch, for example. The motor 41 can be provided with the manual override 42 for connecting a hand crank like the hand crank described above. Furthermore, the motor can be replaced by a hand crank for manually powering the lift mechanism 30 without requiring a separate power source.

The bed lift mechanism 30 is easy to assemble and disassemble. Furthermore, the bed lift mechanism 30 is easy to install and can be bought separately to install into the toy trailer 10. The bed frames 120 slide into the power side assembly 200 and the slave side assembly 300 after mounting the frames 204 of the power side assembly 200 and the slave side assembly 300 to the side walls 23 of the toy trailer 10.

Furthermore, the vertical track members 210, 220 are positioned at each of the four corners of the bed frames 120, thereby ensuring a stable structure and allowing space for windows and window dressing therebetween.

The bed lift mechanism 40 provides a bunked bed and can deploy two separate beds 100, 150. This embodiment provides an additional bed and uses space efficiently since the beds 100, 150 are guided by the same frames 204.

The bed lift mechanism 40 of the present invention also provides multiple safety mechanisms to prevent the beds 100, 150 from falling inadvertently. The locking rod 290 and the safety sprocket 243 prevents the beds 100, 150 from drifting downward. The operator must push upward on the locking rod 290 in order to operate the bed lift mechanism 40 to lower the beds 100, 150. The present invention provides a locking mechanism that must be activated in order to move the beds 100, 150.

The present invention provides two telescoping shafts 31, 32. Therefore, if one of the horizontal chains 239 becomes loose and disengages from either the drive sprocket 241 or the slave sprocket 251, the bed lift mechanism 40 would still be operable, and the beds 100, 150 would be prevented from falling since the two telescoping shafts 31, 32 would continue to power both sides of the bed lift mechanism 40.

The drive mechanism 40 does not move with the beds 100, 150 and is permanently fixed via the drive mechanism mounting bracket 235 to the cross bar 230 in the power side assembly 200. Therefore, any power cables for powering the drive mechanism 40 do not have to travel upwards and downwards with the bed frame 100. The power cables can be permanently mounted close to the ceiling 21 of the toy trailer 10, thereby providing an orderly appearance for the bed lift mechanism 40. Since the power cables are mounted close to the ceiling 21 of the toy trailer 10, the present invention also provides a safe environment without the risk of accidentally ripping the power cables.

Having described embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

1. A structure comprising:
a bed;
a first roller chain which extends lengthwise in a vertical direction adjacent to a first side of the bed; and
a second roller chain which extends lengthwise in a vertical direction adjacent to a second side of the bed;
wherein the first chain and the second chain are used to vertically move the bed; and wherein the first chain and the second chain are used to pull the bed upward.

2-10. (canceled)

11. The structure of claim 1 wherein the first chain is at least part of an endless loop and the second chain is at least part of an endless loop.

12. The structure of claim 1 wherein the first chain extends lengthwise in the vertical direction adjacent to a first wall of the structure and the second chain extends lengthwise in the vertical direction adjacent to a second wall of the structure, wherein the first chain cooperates with a first sprocket which rotates on an axis that is perpendicular to the first wall to vertically move the bed; and wherein the second chain cooperates with a second sprocket which rotates on an axis that is perpendicular to the second wall to vertically move the bed.

13-14. (canceled)

15. A recreational vehicle comprising:
a bed;
a first lifting assembly including a first length of chain which extends lengthwise in a vertical direction, the first lifting assembly being coupled to a first side of the bed; and
a second lifting assembly including a second length of chain which extends lengthwise in a vertical direction, the second lifting assembly being coupled to a second side of the bed;
wherein the first length of chain and the second length of chain are used to vertically move the bed; and wherein the first length of chain and the second length of chain are used to pull the bed upward.

16-19. (canceled)

20. The recreational vehicle of claim 15 comprising superposed beds, wherein the first lifting assembly and the second lifting assembly are used to vertically move the beds between a first configuration where the beds are spaced apart and a second configuration where the beds are stowed adjacent to each other.

21. The recreational vehicle of claim 15 wherein the first length of chain is at least part of an endless loop and a second length of chain is at least part of an endless loop.

22. The recreational vehicle of claim 15 wherein the first lifting assembly is coupled to a first wall of the structure and the second lifting assembly is coupled to a second wall of the structure; wherein the first length of chain cooperates with a first sprocket which rotates on an axis that is perpendicular to the first wall to vertically move the bed; and wherein the second length of chain cooperates with a second sprocket which rotates on an axis that is perpendicular to the second wall to vertically move the bed.

23-26. (canceled)

27. A recreational vehicle comprising:
a first pair of guide members each of which defines a channel, the first pair of guide members being coupled to a first wall of the vehicle;
a second pair of guide members each of which defines a channel, the second pair of guide members being coupled to a second wall of the vehicle;
a plurality of chain lengths each of which extends vertically in the channel of a corresponding guide member from the first pair of guide members and the second pair of guide members, the chain lengths being used to vertically move a bed; and
a motor which is used to drive the movement of the chain lengths.

28-30. (canceled)

31. The recreational vehicle of claim 27 wherein each of the plurality of chain lengths is at least part of an endless loop.

32-37. (canceled)

38. A recreational vehicle comprising:
a cargo area which is used to receive an off-road vehicle;
a door used as a ramp to move the off-road vehicle into and/or out of the cargo area;
an upper bed positioned over a lower bed, the upper bed and the lower bed being movable vertically and at least substantially translationally between a first configuration where the upper bed and the lower bed are spaced apart in the cargo area to receive one or more persons to sleep thereon and a second configuration where the upper bed and the lower bed are stowed adjacent to a ceiling of the recreational vehicle; and
a motor used to move the upper bed and the lower bed between the first configuration and the second configuration;
wherein the upper bed is unsupported by the lower bed in the first configuration; and
wherein the lower bed is part of a lower bed assembly which is used to vertically move the upper bed between the first configuration and the second configuration.

39. The recreational vehicle of claim 38 wherein the upper bed and the lower bed move vertically between the first configuration, the second configuration, and a third configuration where one of the beds is positioned in the cargo area to receive one or more persons to sleep thereon and another one of the beds is stowed adjacent to a ceiling of the recreational vehicle.

40-87. (canceled)

88. The recreational vehicle of claim 38 comprising a chain which extends lengthwise in a vertical direction, the chain being used to move the upper bed and the lower bed between the first configuration and the second configuration.

89. The recreational vehicle of claim 88 wherein the chain is at least part of an endless loop.

90-98. (canceled)

99. The recreational vehicle of claim 38 comprising
a rigid support member; and
a gear;
wherein the gear meshes with an engaging portion of the rigid support member to move the upper bed and the lower bed between the first configuration and the second configuration.

100-103. (canceled)

104. The recreational vehicle of claim 38 comprising a drive member which moves along an endless path, the drive member being used to reciprocally move the upper bed and the lower bed vertically along the endless path.

105-113. (canceled)

114. A recreational vehicle comprising:
a cargo area used to receive an off-road vehicle: and
superposed beds which move vertically between a first configuration where the beds are spaced apart in the cargo area, a second configuration where the beds are stowed adjacent to each other, and a third configuration where one of the beds is positioned in the cargo area to receive one or more persons to sleep thereon and another one of the beds is stowed adjacent to a ceiling of the recreational vehicle.

115-119. (canceled)

120. The recreational vehicle of claim 114 comprising a chain which extends lengthwise in a vertical direction, the chain being used to move the superposed beds between the first configuration and the second configuration.

121-124. (canceled)

125. A recreational vehicle comprising:
a first lifting assembly including a flexible drive member which moves along an endless path, the first lifting assembly being coupled to a first wall of the vehicle;
a second lifting assembly including a flexible drive member which moves along an endless path, the second lifting assembly being coupled to a second wall of the vehicle, the second wall being positioned opposite the first wall; and
a bed positioned between the first lifting assembly and the second lifting assembly; wherein the flexible drive members are used to vertically move the bed.

126-128. (canceled)

129. The recreational vehicle of claim 125 wherein each of the flexible guide members comprises a chain.

130. (canceled)

131. The recreational vehicle of claim 125 wherein the first lifting assembly includes a first moving member and a first guide member which defines a channel, the first moving member being coupled to the bed and the flexible drive member included with the first lifting assembly, the first moving member moving vertically in the channel of the first guide member; and the second lifting assembly includes a second moving member and a second guide member which defines a channel, the second moving member being coupled to the bed and to the flexible drive member included with the second lifting assembly, the second moving member moving vertically in the channel of the second guide member.

132-135. (canceled)

136. A recreational vehicle comprising:
a first pair of guide members each of which defines a channel, the first pair of guide members being coupled to a first wall of the vehicle;
a second pair of guide members each of which defines a channel, the second pair of guide members being coupled to a second wall of the vehicle, the second wall being positioned opposite the first wall;
a plurality of flexible drive members each of which is positioned in the channel of a corresponding guide member from the first pair of guide members and the second pair of guide members, each of the flexible drive members moving along an endless path, the flexible drive members being used to vertically move a bed; and
a motor which is used to drive the movement of the flexible drive members.

137-138. (canceled)

139. The recreational vehicle of claim 136 wherein each of the flexible guide members comprises a chain.

140. (canceled)

141. The recreational vehicle of claim 136 comprising a first pair of moving members each of which is coupled to the bed and to the flexible drive member and each of which moves vertically in the channel of a corresponding guide member from the first pair of guide members; and a second pair of moving members each of which is coupled to the bed and to the flexible drive member and each of which moves vertically in the channel of a corresponding guide member from the second pair of guide members.

142-145. (canceled)
